(19) United States
(12) Patent Application Publication
(10) Pub. No.: US 2017/0255691 A1
(43) Pub. Date: Sep. 7, 2017

(54) INFORMATION PROCESSING SYSTEM, INFORMATION PROCESSING METHOD, AND PROGRAM

(71) Applicant: NEC Personal Computers, Ltd., Tokyo (JP)

(72) Inventor: Tsuyoshi Takemoto, Tokyo (JP)

(73) Assignee: NEC Personal Computers, Ltd., Tokyo (JP)

(21) Appl. No.: 15/444,059

(22) Filed: Feb. 27, 2017

(30) Foreign Application Priority Data
Mar. 1, 2016 (JP) 2016-039055

(51) Int. Cl. G06F 17/30

(52) U.S. Cl. CPC G06F 17/30601; G06F 17/30333; G06F 17/30011

(57) ABSTRACT

The present invention provides an information processing system capable of implementing a recommendation function equivalent to that of the conventional even if the amount of information of databases provided in apparatuses used when the recommendation function is implemented is reduced. A server stores terms appearing in all documents and the total appearance frequencies of the terms in such a manner that terms similar in appearance tendency are grouped and documents similar in term appearance tendency are grouped, generates, from a stored two-dimensional database, a one-dimensional database stored for each total term cluster, and transmits the generated one-dimensional database to an information processing apparatus. The information processing apparatus stores terms appearing in all user documents and appearance frequencies of the terms as a user database in which terms similar in appearance tendency are grouped and user documents similar in term appearance tendency are grouped, extracts a word, identifies a term cluster high in degree of similarity to a document, selects a keyword, and acquires a content associated with the keyword.

### FIELD OF THE INVENTION

The present invention relates to an information processing system, an information processing method, and a program.

### BACKGROUND OF THE INVENTION

Conventionally, there has been a recommendation technique which provides, based on the name of a product or a predetermined keyword, content information estimated to be high in degree of user's interest. The conventional recommendation technique is to store information on documents viewed by the user in the past in order to provide a content searched for using, as a keyword, a term whose frequency of appearance is high among terms included in the documents. In recent years, a technique has been disclosed, which generates a database in which a category to which each document belongs and each term in the document are clustered based on documents viewed by a user in the past so that a content can be provided based on the database from a keyword that matches the user's taste.

It can be said that simply setting, as a keyword, a word included in documents viewed by the user in the past is insufficient to search for a content truly matching the user's taste. The recent recommendation technique has drawn attention in that categories to which documents viewed by a user in the past belong and terms in the documents are clustered to be able to provide an appropriate content from the category of a document being currently viewed by the user and the category of a product or service that matches the user's taste.

However, when a two-dimensional database in which documents and terms are clustered respectively is generated from information on the documents viewed in the past, the amount of information becomes enormous to increase the processing load when a series of processes to generate a database and select a keyword estimated to be high in degree of user's interest is executed, resulting in a problem that the performance of an apparatus is lowered.

Therefore, there are growing needs to shorten the amount of time for arithmetic processing performed by the apparatus to select a keyword high in degree of user's interest, and to reduce the memory capacity of the apparatus. For example, it is considered a method of selecting, as a keyword, a word high in degree of user's interest from a one-dimensional database in which either the categories of documents or the categories of terms as words appearing in the documents are clustered. Since information to be clustered is limited to either the categories of documents or the categories of terms, the reduction in the memory capacity of the apparatus holding the database, and shortening of the amount of time for arithmetic processing performed by the apparatus can be expected.

In other words, a technique capable of reducing the amount of information held by an apparatus and reducing the recommendation processing load while keeping the performance of the conventional recommendation technique is desired.

In Patent Document 1, a recommendation technique is disclosed, which acquires content information from a website or the like, extracts a keyword associated with the content information, extracts two search words, i.e., the keyword and an additional word associated with a category belonging to the content information, and provides a content based on the search words.

This technique is similar to the present application in that a keyword associated with content information is extracted, but such a problem that an enormous amount of data included in the content information acquired from the website are stored inside a device and hence the performance of the device is lowered is unsolved.

[Patent Document 1] Japanese Patent Application Publication No. 2014-215949

### SUMMARY OF THE INVENTION

The present invention has been made in view of the above-mentioned problem, and it is an object thereof to provide an information processing system capable of offering the performance of an apparatus equivalent to that of the conventional even when the amount of information of a database provided in the apparatus used to implement a recommendation function is reduced.

The information processing system according to the present invention is an information processing system capable of being implemented on condition that a server and an information processing apparatus are connected through a network, wherein the server includes: a two-dimensional database section which stores terms as words appearing in all documents accessible via the network, and total appearance frequencies of the terms with respect to all terms appearing in all the documents in such a manner that terms similar in appearance tendency in all the documents are grouped and documents similar in term appearance tendency are grouped; a one-dimensional database generating section which generates, from the stored two-dimensional database, a one-dimensional database in which the terms and the total term appearance frequencies are stored for each total term cluster obtained by grouping the terms similar in appearance tendency in all the documents; and a one-dimensional database transmitting section which transmits the generated one-dimensional database to the information processing apparatus, and the information processing apparatus includes: a user database section which stores terms as words appearing in all user documents, and appearance frequencies of the terms with respect to all terms appearing in all the user documents, as a user database in which terms similar in appearance tendency in all the user documents are grouped and user documents similar in term appearance tendency are grouped; a word extraction section which extracts a word from a specified document; a total term cluster identifying section which identifies, based on the extracted word, a total term cluster high in degree of similarity to the specified document; a keyword selection section which selects a keyword from the terms belonging to the identified total term cluster; and a content acquisition section which acquires, from the network, a content associated with the selected keyword.

According to the present invention, a recommendation function equivalent to that of the conventional can be provided even if the amount of information of databases provided in apparatuses used when the recommendation function is implemented is reduced.

### BRIEF DESCRIPTION OF THE DRAWINGS

FIG. 1 is a hardware configuration diagram of an information processing system according to an embodiment of the present invention.

FIG. 2 is a functional block diagram of the information processing system according to the embodiment of the present invention.

FIG. 3 is a diagram illustrating an example of an article in a document being viewed by a user according to the embodiment of the present invention.

FIG. 4 is a diagram illustrating an example of a two-dimensional database according to the embodiment of the present invention.

FIG. 5(a) is a diagram illustrating an example of a database in which terms similar in term appearance tendency and appearing in all documents are clustered according to the embodiment of the present invention, and FIG. 5(b) is a diagram illustrating an example of identifying a term cluster, from which a keyword is selected based on the appearance tendencies of terms appearing in a document being viewed, according to the embodiment of the present invention.

FIG. 6 is a diagram illustrating an example of a database, in which terms similar in term appearance tendency and appearing in documents viewed by a user in the past are clustered, according to the embodiment of the present invention.

FIG. 7 is a diagram illustrating an example of selecting, as a keyword, a term high in degree of user's interest according to the embodiment of the present invention.

FIG. 8 is a flowchart of the information processing system according to the embodiment of the present invention.

### DETAILED DESCRIPTION OF THE INVENTION

An embodiment of the present invention will be described in detail below.

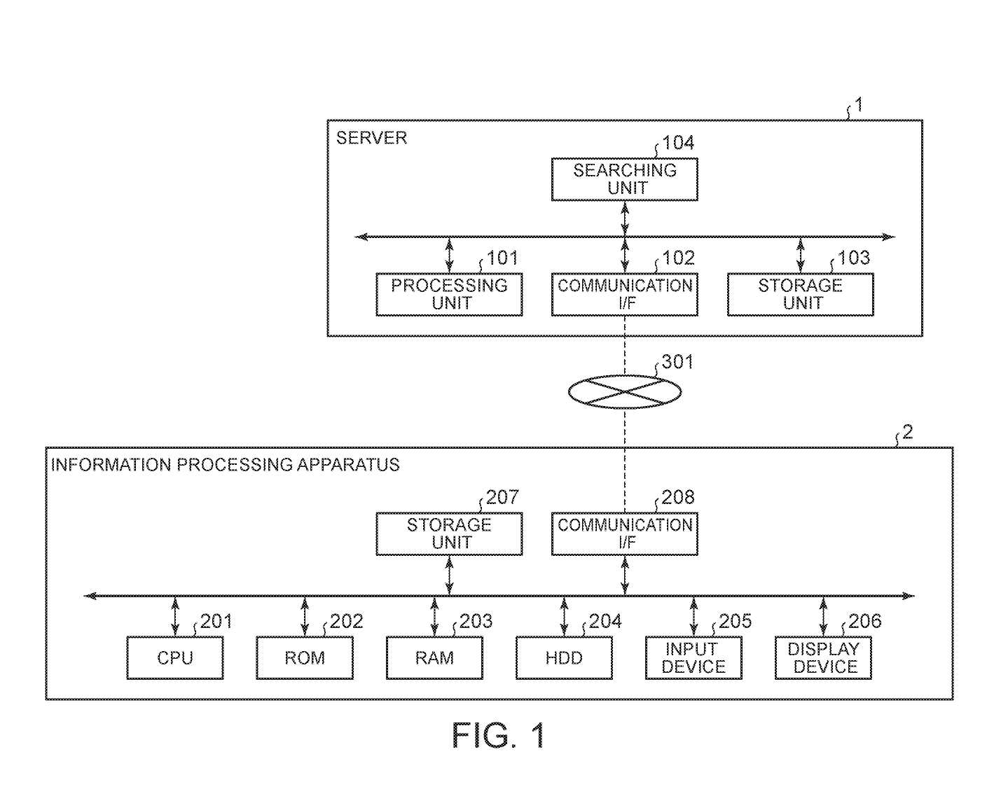

A hardware configuration of an information processing system of the embodiment will be described with reference to FIG. 1. Note that the configuration of the information processing system is not necessarily the same configuration as that illustrated in FIG. 1, and it is enough to include hardware capable of realizing the embodiment.

A server 1 includes a processing unit 101 to control the entire server 1 by executing a predetermined program, a communication I/F 102, a storage unit 103, and a searching unit 104.

The communication I/F 102 of the server 1 connects the server 1 to a network 301 to send and receive information. Specifically, the communication I/F 102 is a USB port, a LAN port, a wireless LAN port, or the like, and any of them may be used as long as it can exchange data with external devices.

The storage unit 103 of the server 1 stores various data in a nonvolatile manner. The various data may be data received from the network 301 through the communication I/F 102, or data received from any other device. Specifically, the storage unit 103 can be a nonvolatile storage device such as an HDD.

The searching unit 104 of the server 1 makes a search in response to a search request accepted by the communication I/F 102 via the network 301, and sends the search results to a requestor. The search here is made to identify information having predetermined association with a keyword included in the search request. In addition to the data held in the server 1, the search request can be made to an information holding apparatus different from the server 1 to make the search.

An information processing apparatus 2 includes a CPU 201 which executes a predetermined program to control the entire information processing apparatus 2, a ROM (Read Only Memory) 202 storing a program to be read by the CPU 201 when the information processing apparatus 2 is powered on, a RAM (Random Access Memory) 203 used by the CPU 201 as a working memory, an HDD 204 capable of holding various data records when the information processing apparatus 2 is powered off, an input device 205 composed of a mouse and input keys, and a display device 206 provided with a display using panels such as liquid crystal and organic EL.

The information processing apparatus 2 further includes a storage unit 207 and a communication I/F 208. The communication I/F 208 is connected to the server 1 through the network 301. The information processing apparatus 2 can access various pieces of information accessible via the network 301 according to user operations. The information processing apparatus 2 corresponds to, but is not limited to, a personal computer, a tablet terminal, or a smartphone.

The storage unit 207 of the information processing apparatus 2 stores various data in a nonvolatile manner. The various data may be received from the network 301 through the communication I/F 208, or received from any other device. Specifically, the storage unit 207 is, but not limited to, a nonvolatile storage device such as an HDD.

The communication I/F 208 of the information processing apparatus 2 is connected to the network 301 to send and receive information. Specifically, the communication I/F 208 is a USB port, a LAN port, a wireless LAN port, or the like, and any of them may be used as long as it can exchange data with external devices.

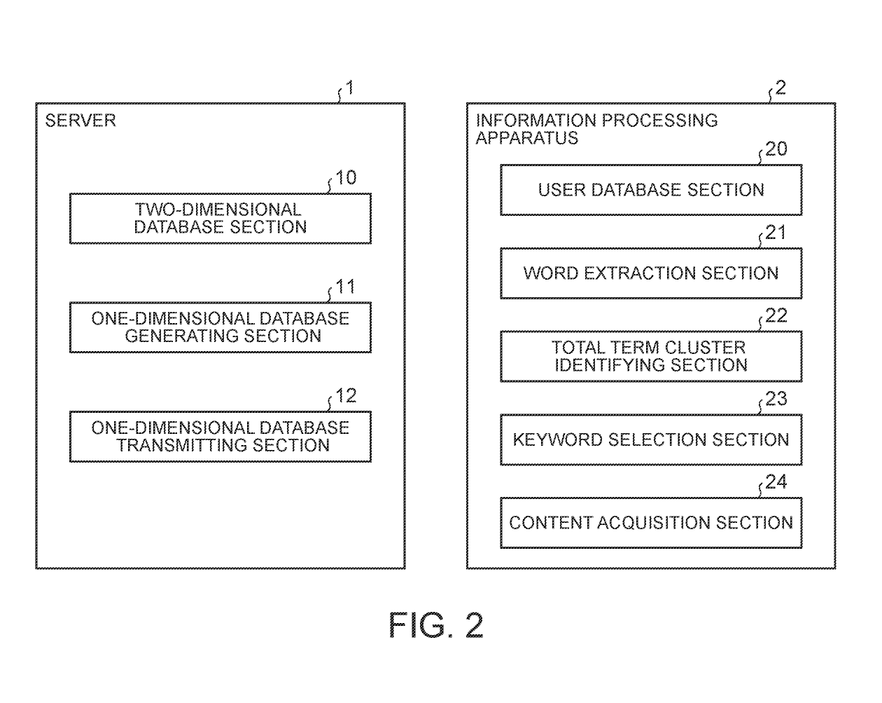

FIG. 2 is a functional block diagram of the information processing system according to the embodiment of the present invention. As illustrated in FIG. 2, the information processing system according to the present invention is such that the server 1 includes a two-dimensional database section 10, a one-dimensional database generating section 11, and a one-dimensional database transmitting section 12, and the information processing apparatus 2 includes a user database section 20, a word extraction section 21, a total term cluster identifying section 22, a keyword selection section 23, and a content acquisition section 24.

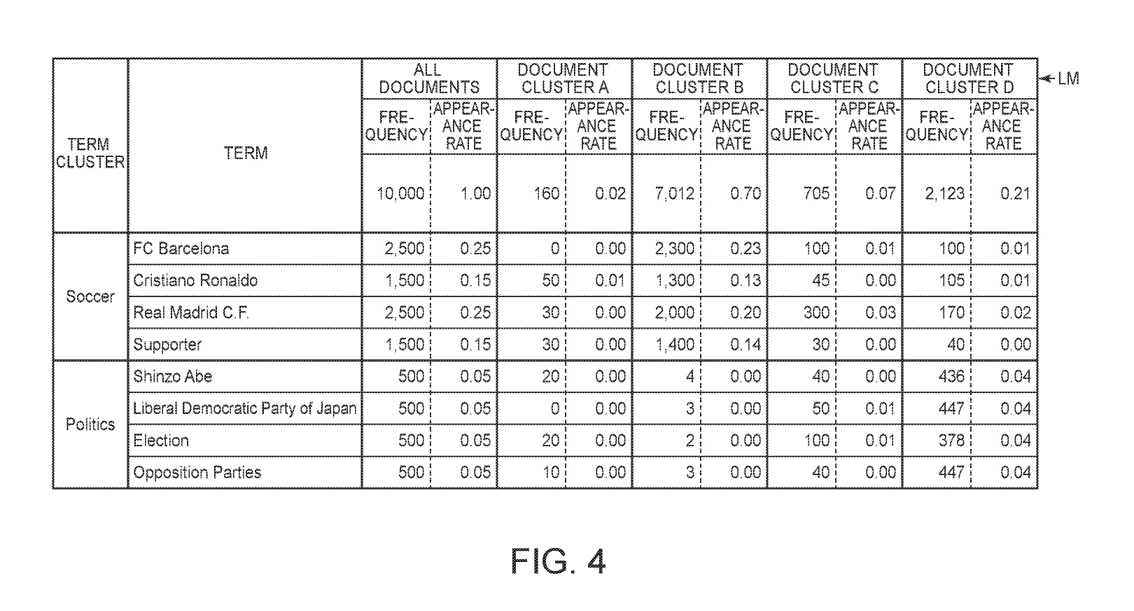

The two-dimensional database section 10 of the server 1 stores a database, for example, as illustrated in FIG. 4. FIG. 4 illustrates a database composed of document clusters (horizontal direction) in each of which documents similar in term appearance tendency are grouped among documents accessible via the network, and term clusters (vertical direction) in each of which terms similar in appearance tendency in the documents are grouped. The two-dimensional database section 10 calculates the appearance rate of each term in each document cluster from the number of appearances in all documents, and stores the appearance rate.

The details of the two-dimensional database will be described. As illustrated in FIG. 4, data are stored in the form of a table in which, among terms appearing in documents, terms similar in appearance tendency in the documents and the documents are grouped. Note that the documents here mean all documents that all users can view on sites, such as articles associated with social sites. When seeing about document components, it is found that terms belonging to a term cluster “Soccer” have high appearance frequencies in a document cluster B. In other words, it can be said that the document cluster B is a cluster of documents associated with soccer.

For example, generation methods of a clustered database, in which a degree of similarity in appearance tendency of terms appearing in the documents is determined to cluster the terms, include non-hierarchical methods such as K-means, and hierarchical methods such as the Ward's method, the centroid method, and the medial method, but the present invention is not limited to these methods as long as collections of data can be grouped into some groups according to the degree of similarity (or the degree of dissimilarity) between data.

The two-dimensional database section 10 stores predetermined data, for example, in the storage unit 103, which can be implemented by the processing unit 101 executing a predetermined database management program.

The one-dimensional database generating section 11 of the server 1 generates, from the stored two-dimensional database, a one-dimensional database in which terms and total appearance frequencies of the terms are stored for each total term cluster, which is a group of terms similar in appearance tendency in all the documents mentioned above.

In the present invention, there is proposed a method of generating, from the two-dimensional database of FIG. 4 considered in a conventional recommendation system, a one-dimensional database of groups of only term cluster components without considering documents, i.e., document components grouped by article category. When terms are clustered by the above method, since the terms are clustered as term cluster components, the appearance tendency and appearance frequency of each term in each term cluster can be read even if the document components are not considered. Therefore, it can be determined to enable the selection of a sufficient keyword reflecting the user's taste.

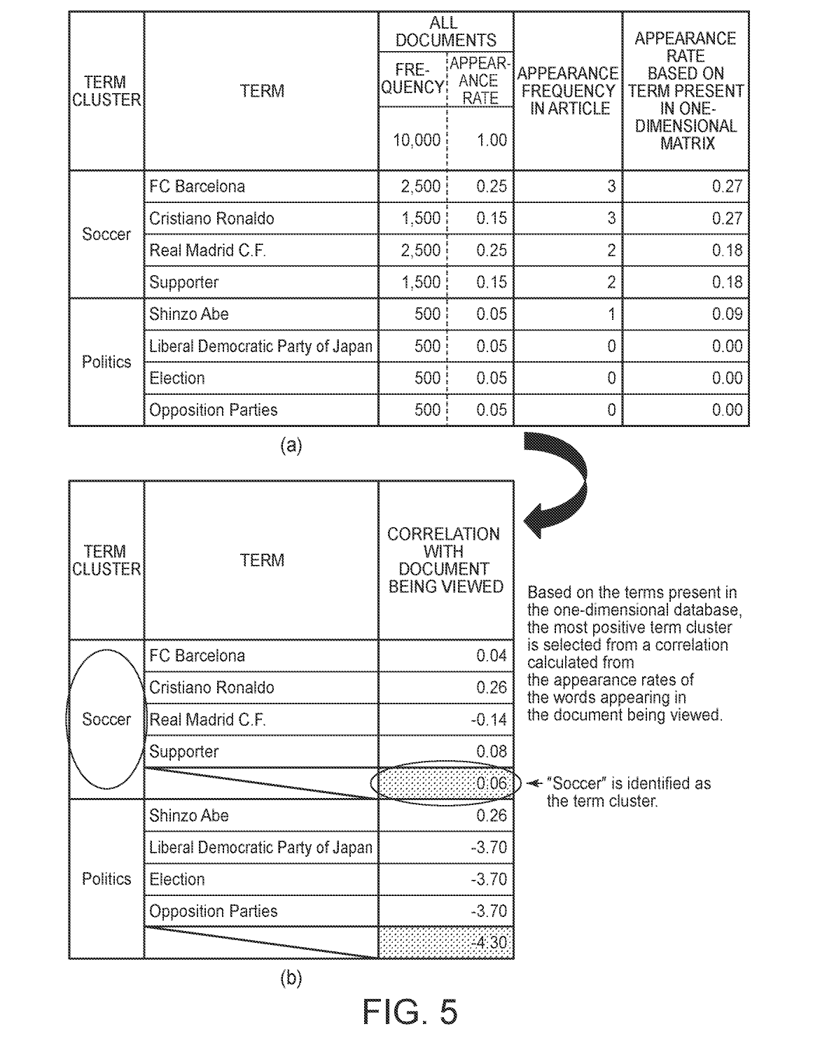

An example of generating a one-dimensional database obtained by excluding document components from the two-dimensional database is illustrated in FIG. 5(a). In FIG. 5(a), term cluster components are listed in the vertical direction as term clusters that are term groups such as “Soccer” and “Politics,” but only the item of “ALL DOCUMENTS,” i.e., the item as the sum of the document clusters A to D is reflected as the document component. For example, the frequency of appearance of the term “FC Barcelona” is 2,500, and this is the frequency of appearance in all documents of the database stored.

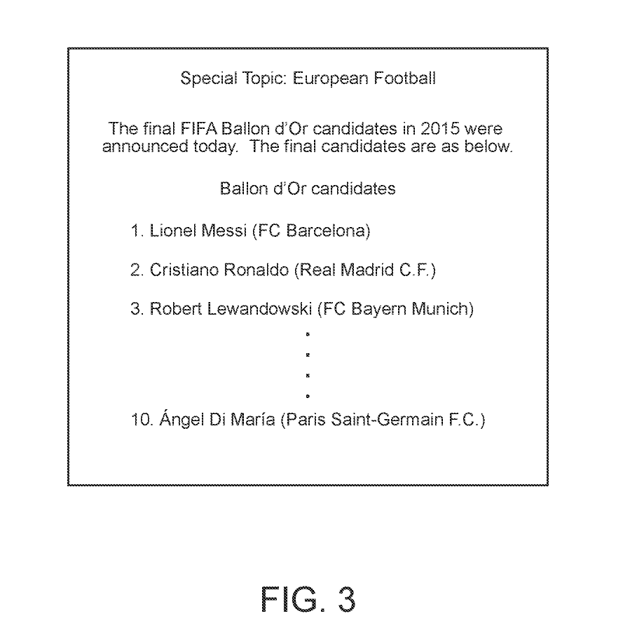

In FIG. 5(a), it is assumed that each term cluster contains four terms for the purpose of illustration. Suppose first that a user is viewing a document as illustrated in FIG. 3. The terms appearing in the document being viewed include “FC Barcelona,” “Cristiano Ronaldo,” and the like, which appear in the document at an appearance frequency in the article as illustrated in FIG. 5(a).

It can be read also from FIG. 5(a) that the term “FC Barcelona” belongs to a term cluster of “Soccer.” Thus, even when the article category as a document component is excluded, terms associated with soccer can be aggregated naturally in the term cluster “Soccer.” It can also be expected to reduce the capacity of the database significantly by excluding the document components.

The one-dimensional database generating section 11 stores predetermined data, for example, in the storage unit 103, which can be implemented by the processing unit 101 executing the predetermined database management program.

The one-dimensional database transmitting section 12 transmits the generated one-dimensional database to the information processing apparatus, i.e., a client PC or the like.

For example, the one-dimensional database transmitting section 12 can be implemented by the processing unit 101 executing the predetermined database management program through the network 301 via the communication I/F 102.

The user database section 20 of the information processing apparatus 2 stores each term as a word appearing in all user documents and the appearance frequency of the term with respect to all terms appearing in all the user documents for each user term cluster in which terms similar in appearance tendency in all the user documents are grouped. A different point between the whole database in FIG. 4 and the user database is that the whole database is generated from all documents, whereas the user database is generated from documents viewed by the user in the past.

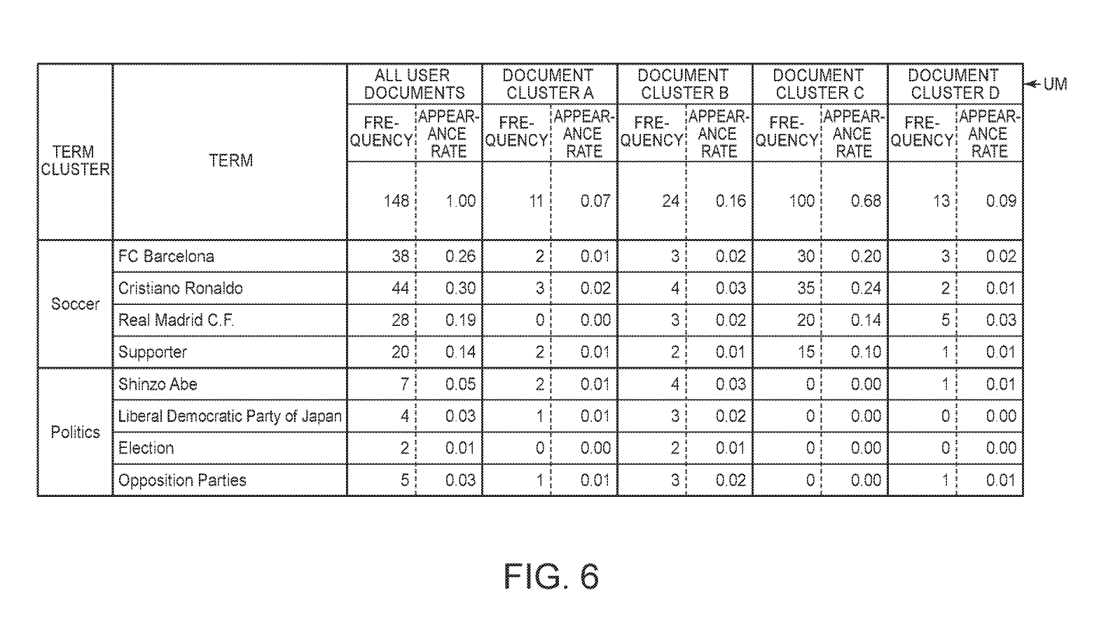

As an example of the user database, a database as illustrated in FIG. 6 is considered. The user documents can be defined as groups of documents viewed by the user in the past, and compiled and stored as a database in the same format as the two-dimensional database in FIG. 4. For example, generation methods of the user database include non-hierarchical methods such as K-means, and hierarchical methods such as the Ward's method, the centroid method, and the medial method, but the present invention is not limited to these methods as long as collections of data can be grouped into some groups according to the degree of similarity (or the degree of dissimilarity) between data.

The user database section 20 stores predetermined data, for example, in the storage unit 207, which can be implemented by the CPU 201 executing a predetermined database management program.

The word extraction section 21 of the information processing apparatus 2 extracts a word from a specified document. Here, the specified document means a content having corresponding text, such as a web page with a news article being currently viewed by the user as illustrated in FIG. 3. The term “specified” here means that the document is selected from multiple targets. The document may be selected by the user, or by the information processing apparatus according to a predetermined algorithm.

For example, the word can be extracted by performing morphological analysis on the text corresponding to the specified document. The word extraction section 21 can be implemented by the CPU 201 executing the predetermined database management program.

The total term cluster identifying section 22 of the information processing apparatus 2 identifies, based on the extracted word, a term cluster having a high degree of similarity to the specified document. Note that the information processing apparatus 2 can receive the one-dimensional database, generated by the one-dimensional database generating section, from the server 1, for example, through the network 301 via the communication I/F 208, and the received one-dimensional database can be stored in the storage unit 207 or the like, and read at timing desired by the user.

Suppose that a term cluster highest in similarity to the document in FIG. 3 is identified from the data illustrated in FIG. 5(a), where the words “FC Barcelona” and “Cristiano Ronaldo” are extracted three times, the words “Real Madrid C.F.” and “supporter” are extracted twice, and the word “Shinzo Abe” is extracted once from the specified document in FIG. 3.

First, the appearance rates of terms appearing in the database generated by the one-dimensional database generating section 11 as the words appearing in the document in FIG. 3 being viewed are calculated. As described above, among the words appearing in the document being viewed, since those corresponding to the one-dimensional database are “FC Barcelona” and “Cristiano Ronaldo” appearing three times, “Real Madrid C.F.” and “supporter” appearing twice, and “Shinzo Abe” appearing once, the appearance frequencies of the words are 11 times.

Next, when the appearance rate of each term is calculated based on 11 times as the sum of appearance frequencies, “FC Barcelona” and “Cristiano Ronaldo” are 0.27, “Real Madrid C.F.” and “supporter” are 0.18, and “Shinzo Abe” is 0.09. These are the appearance rates of the words appearing in the document being viewed based on the terms corresponding to the one-dimensional database.

Next, as illustrated in FIG. 5(b), a correlation between the appearance rate of each term stored in the one-dimensional database, and the appearance rate of each word appearing in the document being viewed is calculated. It can be said that this correlation can be considered as an index to measure whether each word appearing in the document being viewed is stronger or weaker than the term in all the documents, i.e., how positive the word belonging to the term cluster is. It can be said that the more positive (larger in value) the calculated correlation, the higher the user's interest.

As a correlation calculation method, for example, the correlation can be calculated by taking the logarithm (log) of the appearance rate of each term in the one-dimensional database to the appearance rate of each word in the document being viewed. Taking the logarithm (log) of a fraction of the appearance rate of the term in the one-dimensional database as a denominator and the word appearing in the document being viewed as a numerator leads to such a simple calculation result that the word is calculated to take a more positive value as the appearance rate of the word appearing in the document being viewed is higher. In specifying the total term cluster, a correlation between the appearance rate of each term cluster relative to the whole one-dimensional database and the appearance rate of the word appearing in the document being viewed relative to each term cluster is calculated to identify a term cluster higher in correlation than this calculated correlation.

The total term cluster identifying section 22 can be implemented by the CPU 201 executing a predetermined program.

The keyword selection section 23 selects a keyword from the terms belonging to the term cluster identified. For example, a term with a high appearance frequency in the identified term cluster can be selected as the keyword. Alternatively, the appearance frequencies of certain terms can also be compared between the term cluster identified from data on all documents and the user term cluster of the user database identified from data on all user documents to select a keyword with a high appearance frequency in the user term cluster.

As described with reference to FIG. 5, “FC Barcelona,” “Cristiano Ronaldo,” “Real Madrid C.F.,” “supporter,” and “Shinzo Abe” are extracted from the specified document, and “Soccer” is identified as the term cluster associated with this document. In this case, a case is considered where a word in which the user's interest is high is selected as a keyword from “Soccer” as the identified term cluster.

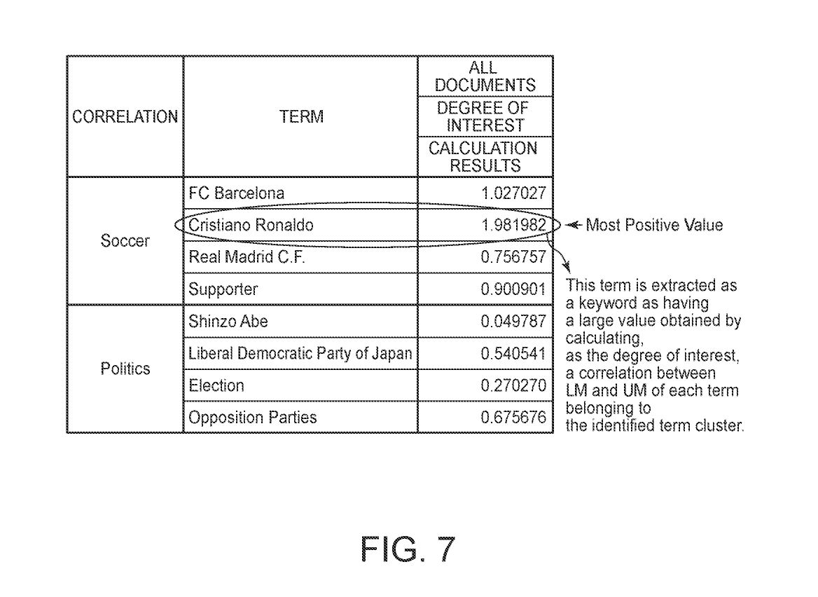

FIG. 7 illustrates a correlation between the appearance frequency of each term belonging to each term cluster in the whole database and the appearance frequency of the term in the user database. For example, when the appearance frequency is high in the user database even though it is low in the whole database, it can be considered that the correlation is strong and the term is a word in which the degree of interest specific to the user is high. Therefore, it can be said that the term is suitable as a keyword to be recommended to the user.

In the term cluster “Soccer” in this case, the word exhibiting a high correlation is “Cristiano Ronaldo,” and in the whole database, a word with a high appearance frequency among words belonging to the term cluster “Soccer” is “FC Barcelona.” However, the word “Cristiano Ronaldo” in which the degree of interest specific to the user is high can be selected as a keyword by calculating the correlation with the user database as illustrated in FIG. 7.

The keyword selection section 23 can be implemented by the CPU 201 executing the predetermined program.

The content acquisition section 24 acquires, from the network, a content associated with the selected keyword. The content associated with the keyword is acquired, for example, by sending a search request together with the keyword to a retrieval server or the like connected through the network 301, and receiving, from the retrieval server or the like, the retrieval results as information having predetermined association with the keyword. The content acquisition section can be implemented by the CPU 201 executing the predetermined program, and the communication I/F 208 performing communication through the network 301 as needed.

The content may be displayed in an area different from the area of the document on the screen through the display device 206, or displayed by adding the content into the document. When the document does not fit in one screen, the content may be added to and displayed in the area of the document that does not fit in one screen. In this case, the user can view the entire content by performing a scroll operation. Even so, however, the user can easily grasp that the content is displayed in association with the document.

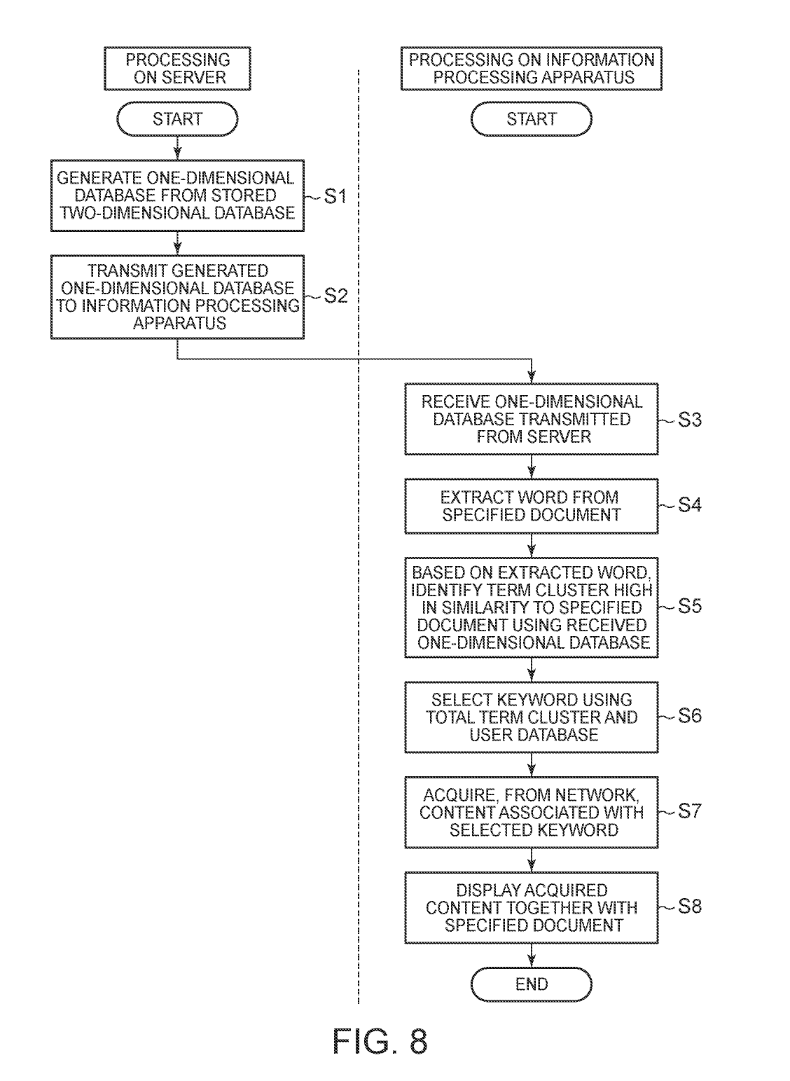

Referring next to FIG. 8, a flow of processing for carrying out the information processing system of the embodiment will be described. FIG. 8 is a flowchart related to processing for the information processing system according to the embodiment of the present invention.

First, a flow of processing performed by the server 1 will be described. A one-dimensional database is generated from a two-dimensional database stored (step 1). For example, the one-dimensional database may be generated at the same timing as the periodical updating of the two-dimensional database as basic data, or may be generated according to a generation instruction from a user.

The generated one-dimensional database is transmitted to the information processing apparatus 2, i.e., to a PC or the like owned by the user (step 2). The timing of transmitting the one-dimensional database may be instructed by the user, or may be when the user views the document through the network.

Next, processing performed by the information processing apparatus 2 will be described. The one-dimensional database transmitted from the server 1 is received (step 3). Then, a word is extracted from a specified document (step 4). Next, based on the extracted word, a term cluster high in degree of similarity to the specified document is identified from the received one-dimensional database (step 5). Note that the degree of similarity can be calculated from the appearance rate of the word appearing in the document being viewed and the appearance rate of the term in the one-dimensional database.

Using information on the identified term cluster and user database information, a keyword associated with the specified document is selected (step 6). In selecting the keyword, a term suitable for the user can be selected as the keyword from a correlation between the identified term cluster and a term belonging to a user term cluster corresponding to the term cluster. A word with a strong correlation may be selected as the keyword, or otherwise, selection criteria may be provided separately to select the keyword according to the selection criteria.

Next, a content associated with the selected keyword is acquired from the network (step 7). Further, the acquired content is displayed together with the specified document (step 8).

Thus, the processing mentioned above is so performed that the recommendation function equivalent to that of the conventional can be provided even if the information capacities of databases provided in apparatuses used when the recommendation function is implemented is reduced.

In the conventional, for example, as a method of generating a two-dimensional database including document clusters in the X direction and term clusters in the Y direction, clustering in the X direction and clustering in the Y direction are performed alternately to generate a database. Since bidirectional clustering processes are performed alternately, a database in which a specific term appears intensively in a cluster of a specific document is generated.

Since a specific term appears intensively in a specific document cluster, it is clear which term cluster corresponds to which document cluster. In other words, it can be said that the appearance frequency of a term, which appears in a term cluster corresponding to a certain document cluster, in any document cluster other than the corresponding document cluster is insignificant. Since so-called common words (postpositional particle, verbal auxiliary, time-series words, and the like) other than feature words (noun, proper noun, and the like) are likely to appear frequently in all document clusters, it is preferred to exclude these common words in advance before clustering.

Focusing on the points mentioned above, the present invention generates, from the two-dimensional cluster database mentioned above, a one-dimensional database (including only Y-directional term clusters) for all documents containing all document clusters in the other direction (X direction in the present application). Since the appearance frequency of a term, which appears in a term cluster corresponding to a certain document cluster, in any document cluster other than the corresponding document cluster is insignificant, even the one-dimensional database proposed in the present application can realize a recommendation pattern similar to that of the two-dimensional database. Further, the data capacity can be considerably reduced by changing the database from the two-dimensional type to the one-dimensional type, and hence an improvement in the performance of the apparatus can also be expected.

Note that the content provided by a used apparatus, and the number of apparatuses are not limited to those in the embodiment as long as the configuration can carry out the present invention.

As a modification example of the embodiment, for example, processing from step 1 to step 7 in the flow of the information processing system in FIG. 8 can be performed all on the side of the server 1 to reduce the processing load of the information processing apparatus 2. It goes without saying that the information processing system can also be configured by combining whether to perform the processing from step 1 to step 7 on the server side or on the side of the information processing apparatus. In consideration of the present invention which aims at reducing the load of processing performed on the side of the information processing apparatus, such a configuration to cause as many processing steps as possible to be performed on the server side is ideal.

The information processing apparatus 2 used in the embodiment of the present invention can be applied to an electronic device communicable through a network, such as a personal computer, a tablet terminal, or a smartphone.

We claim:

1. An information processing system capable of being implemented with a server and an information processing apparatus connected through a network, comprising:
the server comprises:
a two-dimensional database section which stores terms as words appearing in all documents accessible via the network, and total appearance frequencies of the terms with respect to all terms appearing in all the documents in such a manner that terms similar in appearance tendency in all the documents are grouped as total term clusters and documents similar in term appearance tendency are grouped as other total term clusters;
a one-dimensional database generating section which generates, from the two-dimensional database, a one-dimensional database in which the terms and the total term appearance frequencies are stored for each total term cluster obtained by grouping the terms similar in appearance tendency in all the documents; and
a one-dimensional database transmitting section which transmits the generated one-dimensional database to the information processing apparatus, and
the information processing apparatus comprises:
a user database section which stores terms as words appearing in all user documents, and appearance frequencies of the terms with respect to all terms appearing in all the user documents, as a user database in which terms similar in appearance tendency in all the user documents are grouped and user documents similar in term appearance tendency are grouped;
a word extraction section which extracts a word from a specified document;
a total term cluster identifying section which identifies, based on the extracted word, an identified total term cluster high in degree of similarity to the specified document;
a keyword selection section which selects a keyword from the terms belonging to the identified total term cluster; and
a content acquisition section which acquires, from the network, a content associated with the selected keyword.

2. The information processing system according to claim 1, wherein the total term cluster identifying section calculates a correlation between an appearance frequency of the extracted word for each total term cluster and an appearance frequency of each total term cluster stored in the one-dimensional database to identify, as the identified total term cluster, a term cluster the calculated correlation of which is most positive.

3. The information processing system according to claim 1, wherein the keyword selection section selects the keyword based on a ratio of the terms belonging to the identified total term cluster and the terms belonging to a term cluster identical to the identified total term cluster in the user database.

4. The information processing system according to claim 3, wherein the keyword selection section selects, as the keyword, a term with a maximum ratio.

5. The information processing system according to claim 1, further comprising:
a display section which displays the acquired content together with the specified document.

6. An information processing method capable of being implemented with a server and an information processing apparatus connected through a network, comprising:
the server executes:
storing terms as words appearing in all documents accessible via the network, and total appearance frequencies of the terms with respect to all terms appearing in all the documents in such a manner that terms similar in appearance tendency in all the documents are grouped in total term clusters and documents similar in term appearance tendency are grouped in other total term clusters;
generating a one-dimensional database in which the terms and the total term appearance frequencies are stored for each total term cluster obtained by grouping the terms similar in appearance tendency in all the documents; and
transmitting the generated one-dimensional database to the information processing apparatus, and
the information processing apparatus executes:
storing terms as words appearing in all user documents, and appearance frequencies of the terms with respect to all terms appearing in all the user documents, as a user database in which terms similar in appearance tendency in all the user documents are grouped and user documents similar in term appearance tendency are grouped;
extracting a word from a specified document;
identifying, based on the extracted word, an identified total term cluster high in degree of similarity to the specified document;
selecting a keyword from the terms belonging to the identified total term cluster; and
acquiring, from the network, a content associated with the selected keyword.

7. A program causing a computer to implement an information processing system capable of being implemented with a server and an information processing apparatus are connected through a network, comprising:
the server executes:
storing terms as words appearing in all documents accessible via the network, and total appearance frequencies of the terms appearing in all the documents in such a manner that terms similar in appearance tendency in all the documents are grouped in total term clusters and documents similar in term appearance tendency are grouped in other total term clusters;
generating a one-dimensional database in which the terms and the total term appearance frequencies are stored for each total term cluster obtained by grouping the terms similar in appearance tendency in all the documents; and
transmitting the generated one-dimensional database to the information processing apparatus, and
the information processing apparatus executes:
storing terms as words appearing in all user documents, and appearance frequencies of the terms with respect to all terms appearing in all the user documents, as a user database in which terms similar in appearance tendency in all the user documents are grouped and user documents similar in term appearance tendency are grouped;
extracting a word from a specified document;
identifying, based on the extracted word, an identified total term cluster high in degree of similarity to the specified document;
selecting a keyword from the terms belonging to the identified total term cluster; and
acquiring, from the network, a content associated with the selected keyword.
